(19) United States
(12) Patent Application Publication
(10) Pub. No.: US 2006/0042708 A1
(43) Pub. Date: Mar. 2, 2006

(54) Pipe locking device

(76) Inventor: James Stowe, Tucson, AZ (US)

Correspondence Address: QUARLES & BRADY STREICH LANG, LLP, ONE SOUTH CHURCH AVENUE, SUITE 1700, TUCSON, AZ, 85701-1621, US

(21) Appl. No.: 10/932,211

(22) Filed: Sep. 1, 2004

(51) Int. Cl. F16L 55/10

(52) U.S. Cl. 138/89

(57) ABSTRACT

A locking retention system is used to secure a pipe plug or pipe cap to a pipe. A retention tab is affixed to the pipe plug/cap and is, in turn, secured to the pipe with a lock and either a retention cable or retention strap Alternatively, a plug cover may be placed over a recessed pipe plug and secured with a through-the-hole lock.

### BACKGROUND OF THE INVENTION

1. Field of the Invention

This invention is related in general to pipe locking systems. In particular, the invention consists of a system for securely fastening pipe caps or plugs to prevent their unauthorized removal.

2. Description of the Prior Art

Pipe plugs and caps are traditionally used to seal pipe ends to retain the contents of the pipes and to keep foreign material from entering the pipe. A pipe plug 10, as illustrated in FIGS. 1a and 1b, normally includes threads 12 and a protrusion 14 for gripping with a tool. Pipe caps and plugs are often placed at exposed locations, such as sewer plugs on the outside of a home used as pipe clean-out access points. These caps and plugs are traditionally installed and removed with common tools, such as pipe-wrenches and sockets.

One problem faced by owners of pipe caps and plugs is that they are vulnerable to tampering by unauthorized parties. For example, a malicious person may remove a sewer clean-out cap and place a foreign substance in the pipe, attempting to foul the sewer system. Alternative, this person may leave the cap off, allowing bothersome odors to escape from the sewer system.

One attempt to solve this problem is to utilize special pipe plugs that require specialized tools to install and remove. For example, as illustrated in FIGS. 2a and 2b, a plug 10 may include a recessed area 16 for accepting a specialized tool conforming to the recessed area 16. However, while this may deter a casual vandal, a more determined individual may be able to adapt an unintended tool for use in removing the plug. Therefore, it would be desirable to have a device for locking pipe plugs or caps to prevent their removal.

### SUMMARY OF THE INVENTION

The invention disclosed herein utilizes a locking retention system to secure a pipe cap or pipe plug to an end of a pipe. The locking retention system works by not allowing the pipe cap or pipe plug to be rotated within the pipe, thus preventing the pipe cap or plug from being removed from the pipe. The locking retention system may include a tab located on the exterior surface of the pipe cap/plug, a cable secured to the pipe, and a lock to secure the cable to the tab. Alternatively, the cable may be replaced with a strip of metal intended to fit over the tab and prevented from removal by the lock. Pipe plugs with specialized recessed surfaces (FIG. 1) may utilize locks inserted through the plug, rather than the lock/tab combination. An advantage of this system is that pipe caps or pipe plugs cannot be removed without destroying the locking retention system, making it much more difficult for a casual vandal to remove them.

Various other purposes and advantages of the invention will become clear from its description in the specification that follows and from the novel features particularly pointed out in the appended claims. Therefore, to the accomplishment of the objectives described above, this invention comprises the features hereinafter illustrated in the drawings, fully described in the detailed description of the preferred embodiments and particularly pointed out in the claims. However, such drawings and description disclose just a few of the various ways in which the invention may be practiced.

### BRIEF DESCRIPTION OF THE DRAWINGS

FIG. 1a is a side view of a pipe plug.

FIG. 1b is a top view of the pipe plug of FIG. 1a.

FIG. 2a is a side view of a specialized pipe plug including a recessed area.

FIG. 2b is a top view of the specialized pipe plug of FIG. 1a.

FIG. 3a is an illustration of a locking retention system, according to the invention, including a pipe plug, a retention tab, a retention cable, and a lock.

FIG. 3b is an illustration of the locking retention system of FIG. 3a, including a threaded pipe adapter.

FIG. 3c is an illustration of the locking retention system of FIG. 3a, including a coupling.

FIG. 3d is an illustration of the locking retention system of FIG. 3a, wherein the pipe plug has been replaced by a pipe cap.

FIG. 4a is an illustration of a locking retention system, according to the invention, including a pipe plug, a retention tab, a retention strap, and a lock.

FIG. 5a is an illustration of a locking retention system, according to the invention, including a recessed pipe plug, a plug cover, and a through-the-plug lock.

FIG. 5b is a top view of the recessed pipe plug of FIG. 5a.

FIG. 5c is a side view of the recessed pipe plug of FIG. 5a.

FIG. 5d is a side view of the plug cover and the through-the-plug lock of FIG. 5a.

FIG. 5e is a top view of the recessed pipe plug, the plug cover, and through-the-plug lock of FIG. 5a.

FIG. 5f is a bottom view of the recessed pipe plug and through-the-plug lock of FIG. 5a.

FIG. 6 is a flow chart illustrating a process of securing a pipe plug to a pipe.

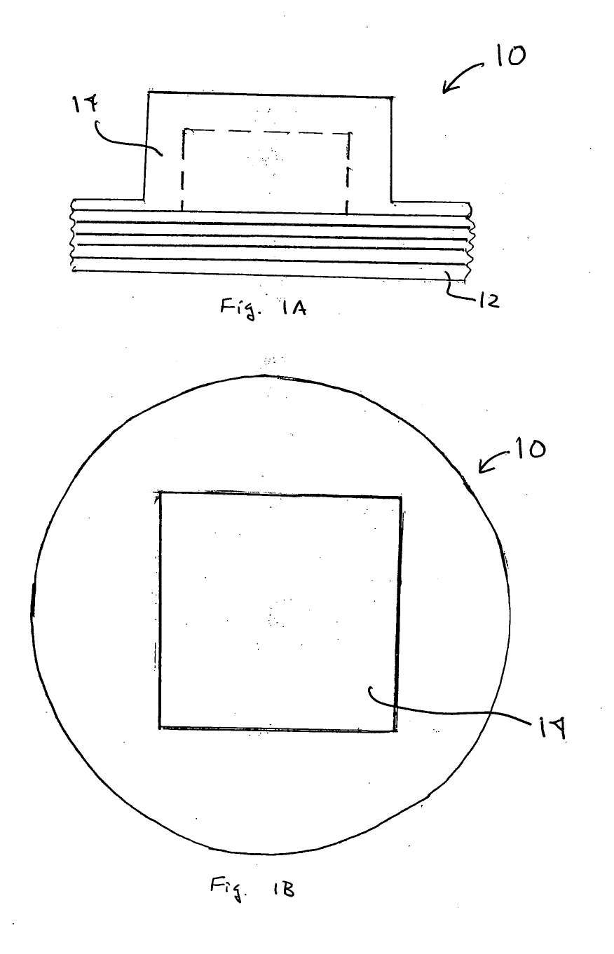

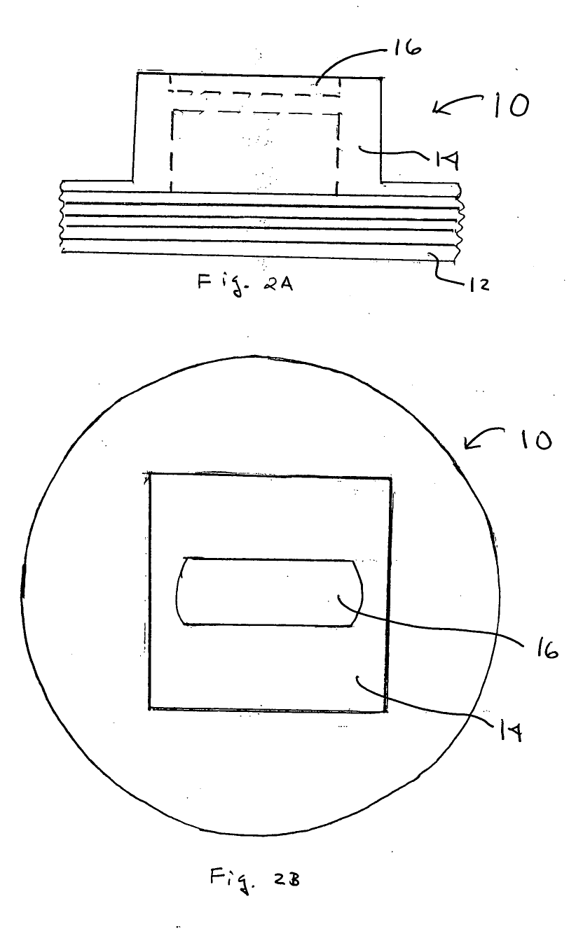

### DESCRIPTION OF THE PREFERRED EMBODIMENTS

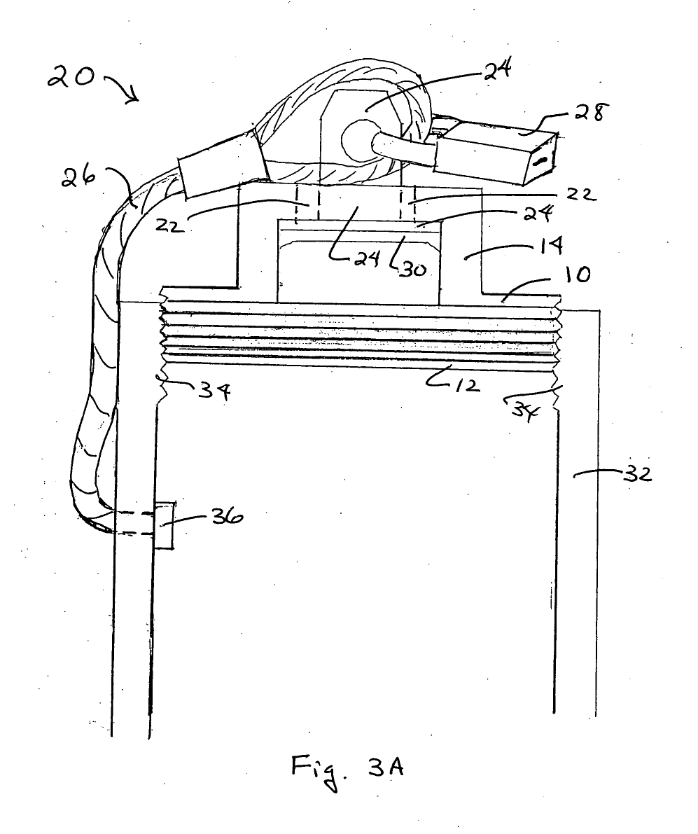

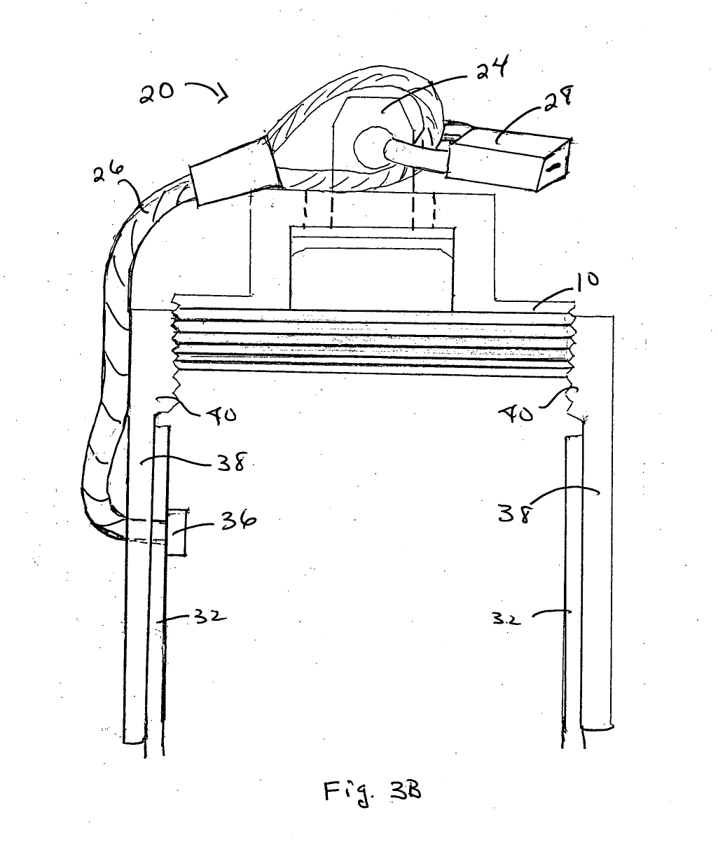

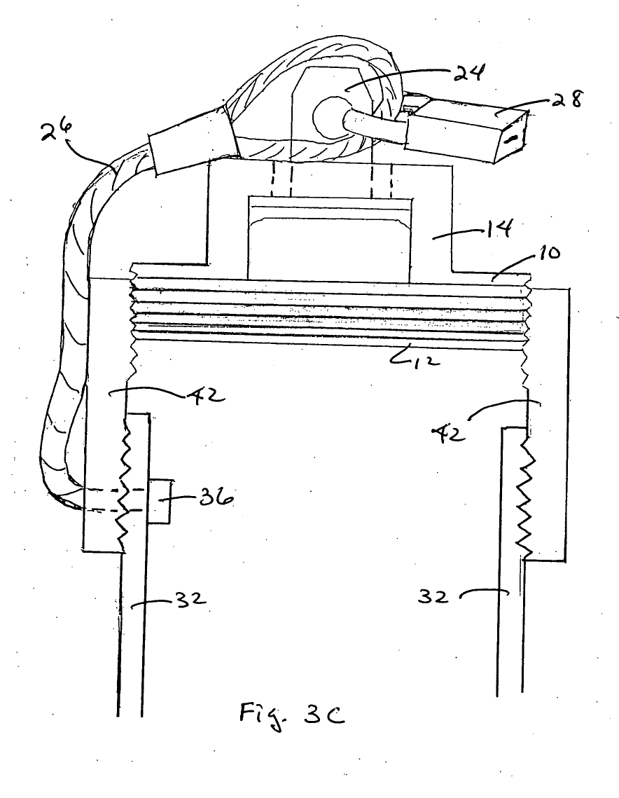

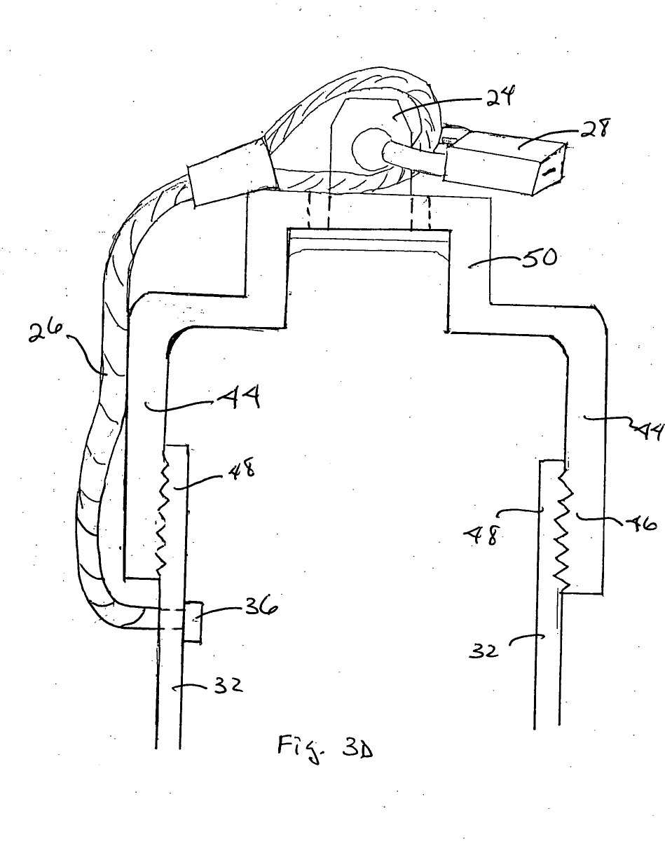

This invention is based on the idea of utilizing a locking retention system to prevent the removal of pipe caps or pipe plugs. Referring to figures, wherein like parts are designated with the same reference numerals and symbols, FIG. 3a is an illustration of a locking retention system 20, according to the invention, including a pipe plug 10, a retention tab 24, a retention device 26, and a lock 28. The retention tab is made from a hard material, such as ABS plastic or metal, and inserted through a hole 22 in the protrusion 14. In this embodiment of the invention, the retention tab 24 is sealed into the pipe plug 10 using an epoxy 30 or glue. In this embodiment of the invention, the retention device 26 is a retention cable.

The pipe plug 10 is screwed into a pipe 32 with interior female threads 34 and secured by the lock 28 and the retention cable 26 to the pipe 32 by a crimped end 36. Alternatively, the retention cable 26 may include male threads on one end that are inserted through the pipe 32 and secured by a nut. Another method of securing the retention cable 26 to the pipe 32 is by braising the retention cable. Once locked in place, the pipe plug 10 cannot be rotated and is therefore prevented from being removed without first removing the lock 28. In one embodiment of the invention, the pipe plug 10 is prevented from rotating by the retention cable 26 being secured with little or no slack. Alternatively, the pipe plug 10 may be prevented from rotating if the retention cable 26 is too stiff or includes a stiff coating that prevents it from twisting.

In FIG. 3b, a threaded adapter 38, including interior female threads 40, is glued to the pipe 32 with an epoxy or pipe cement. FIG. 3c illustrates the locking retention system 20 with the threaded adapter (FIG. 3b) replaced with a double-threaded coupling 42. In another embodiment of the invention, as illustrated in FIG. 3d, the pipe plug 10 is a pipe cap 44 including female interior threads 46 and a protrusion 50 similar to that found in the pipe plug 10. The pipe 32 includes male exterior threads 48 for mating with the female interior threads 46 of the pipe cap 44.

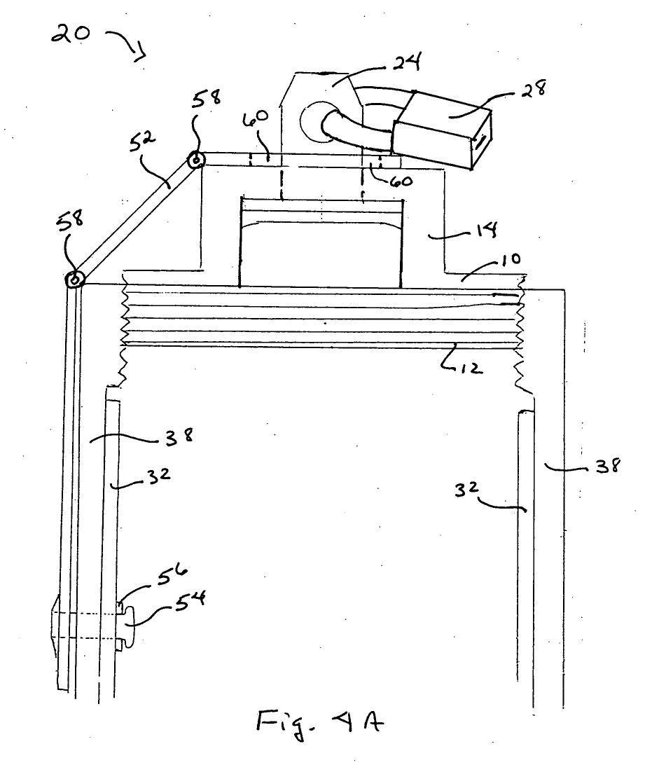

In yet another embodiment of the locking retention system 20, as illustrated in FIG. 4a, the retention cable 26 (FIG. 3b) has been replaced with a retention strap 52, another form of retention device, secured to the pipe 32 with a rivet 54 and a lock washer 56. Alternatively, the retention strap 52 may secured with a bolt and nut. The retention strap 52 includes a slot 60 to allow the retention strap to fit over the retention tab 24. The retention strap 52 may be made from a resilient material, such as steel or plastic, to allow the retention strap 52 to be removed from the retention tab 24 when the lock 28 is not present. Alternatively, the retention strap 52 may be made from a less-resilient material and may include one or more hinges 58 to allow the retention strap 52 to be removed from the retention tab 24. Another embodiment of the retention strap is a flexible cloth or woven metal strap.

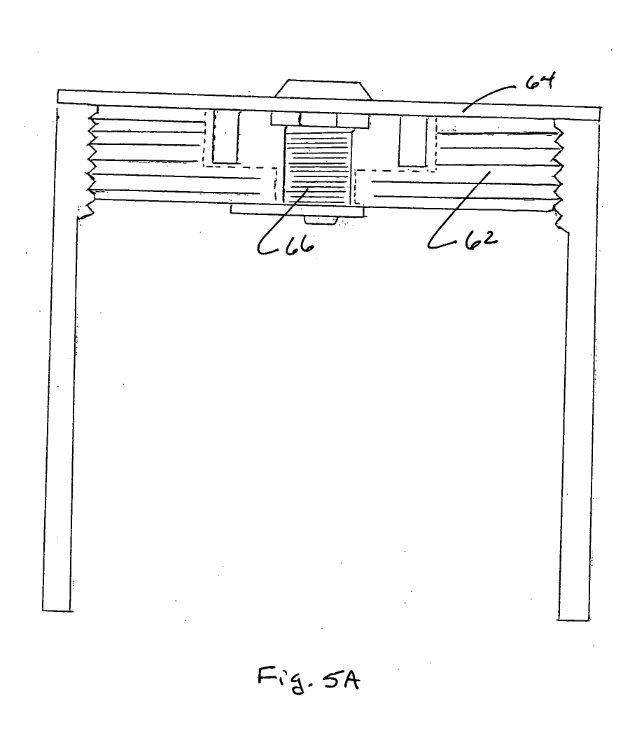

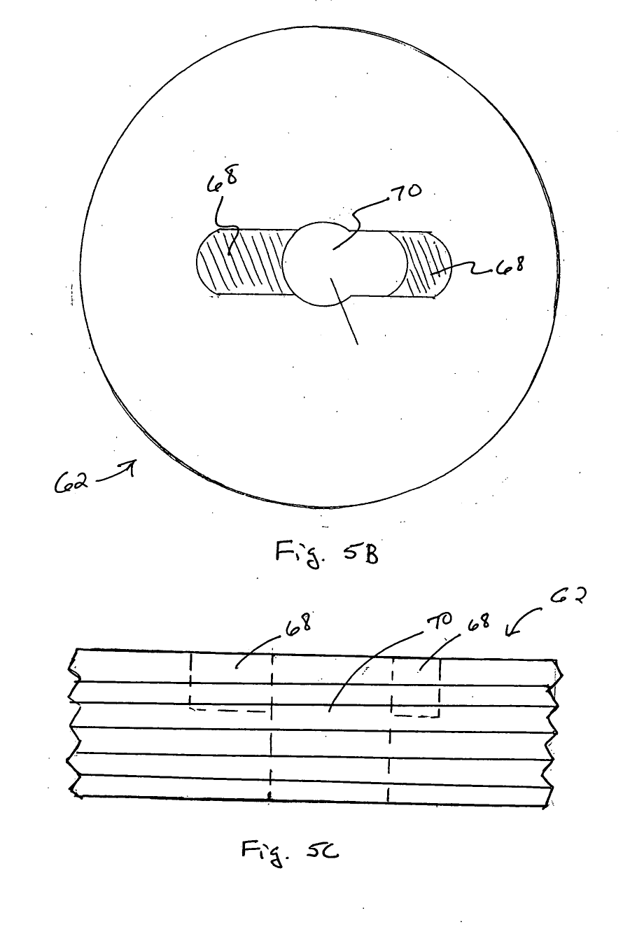

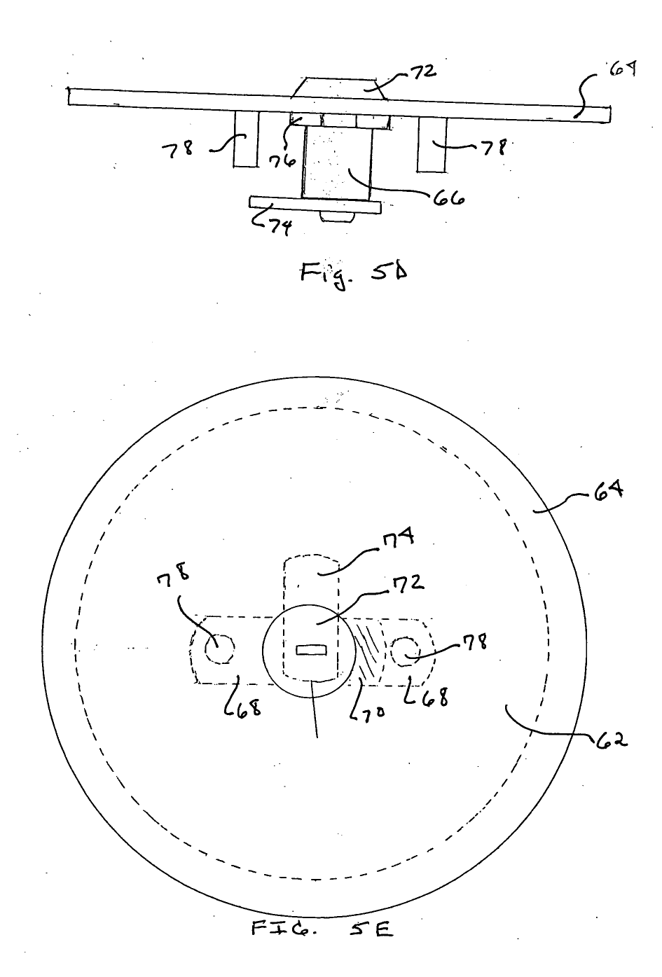

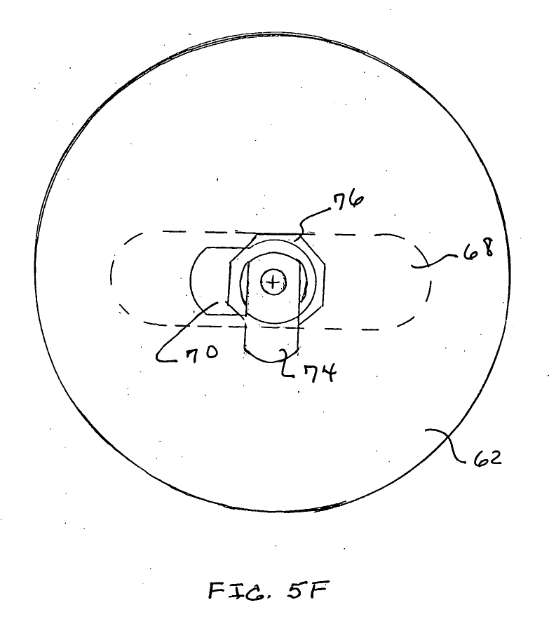

FIG. 5a illustrates an embodiment of the locking retention system 20 including a recessed pipe plug 62, minus any protrusion 14 (FIG. 3a). A plug cover 64 is secured to the recessed pipe plug 62 by a through-the-plug lock 66. FIG. 5b is a top view of the recessed pipe plug of FIG. 5a. FIG. 5b is a top view of the recessed pipe plug 62 including a recessed area 68 and a through-hole 70. FIG. 5c is a side view of the recessed pipe plug 62 of FIG. 5b

FIG. 5d is a side view of the plug cover 64 and the through-the-hole lock 66 of FIG. 5a. The through-the-hole lock 66 includes a barrel 72 for receiving a key, a lock tab 74 which is rotated to prevent the through-the-hole lock 66 from being pulled through the plug cover 64 and a locking nut 76 to secure the through-the-hole lock 66 to the plug cover 64. One or more posts 78 are inserted into the recessed area 68 to prevent the plug cover 64 and the attached through-the-hole lock 66 from rotating. FIG. 5e is a top view of the recessed pipe plug 62, the plug cover 64, and the through-the-plug lock 66 and FIG. 5f is a bottom view of the recessed pipe plug 62 and the through-the-plug lock 66.

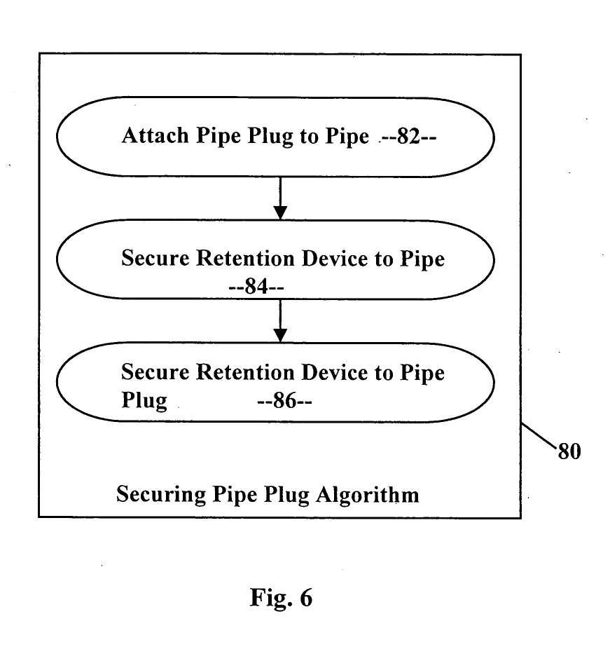

FIG. 6 is a flow chart illustrating a securing pipe plug algorithm 80. In step 82, the pipe plug is attached to an end of the pipe; in step 84 a retention device is secured to the pipe; and in step 86 the retention device is secured to the pipe plug.

Those skilled in the art of making locking retention systems may develop other embodiments of the present invention. For example, a second pipe may be secured to a first pipe with the locking retention system, rather than a pipe plug or pipe cap. However, the terms and expressions which have been employed in the foregoing specification are used therein as terms of description and not of limitation, and there is no intention in the use of such terms and expressions of excluding equivalents of the features shown and described or portions thereof, it being recognized that the scope of the invention is defined and limited only by the claims which follow.

I claim:

1. A locking retention system, comprising:
a pipe;
a pipe plug placed at an end of the pipe; and
a retention device secured to the pipe plug and adapted to prevent the pipe plug from being removed from the pipe.

2. The locking retention system of claim 1, wherein the retention device is a retention cable secured to the pipe.

3. The locking retention system of claim 1, wherein the retention device is a retention strap secured to the pipe.

4. The locking retention system of claim 1, wherein the pipe includes interior threads and the pipe plug includes exterior threads and the pipe plug is rotated into the pipe.

5. The locking retention system of claim 4, wherein the retention device prevents the pipe plug from being rotated out of the pipe.

6. The locking retention system of claim 5, wherein the pipe plug includes a through-hole and the retention device includes a plug cover adapted to cover the pipe plug and the retention device further includes a through-the-hole lock inserted through the through-hole and secured to the plug cover.

7. The locking retention system of claim 1, wherein the pipe plug includes a pipe cap with interior threads and the pipe includes exterior threads and the pipe cap is rotated onto the pipe.

8. The locking retention system of claim 7, wherein the retention device prevents the pipe cap from being rotated off of the pipe.

9. A locking retention system, comprising:
a pipe;
a pipe plug, including a retention tab, placed at an end of the pipe;
a retention device; and
a lock for securing the retention device to the retention tab;
wherein the retention device is adapted to prevent the pipe plug from being removed from the pipe.

10. The locking retention system of claim 9, wherein the retention device is a retention cable secured to the pipe.

11. The locking retention system of claim 9, wherein the retention device is a retention strap secured to the pipe.

12. The locking retention system of claim 9, wherein the pipe includes interior threads and the pipe plug includes exterior threads and the pipe plug is rotated into the pipe and the retention device prevents the pipe plug from being rotated out of the pipe.

13. The locking retention system of claim 9, wherein the pipe plug includes a pipe cap with interior threads and the pipe includes exterior threads and the pipe cap is rotated onto the pipe and the retention device prevents the pipe cap from being rotated off of the pipe.

14. A method of preventing a pipe plug from being removed from a pipe, comprising the steps of:
attaching the pipe plug to an end of the pipe;
securing a retention device to the pipe; and
securing the retention device to the pipe plug.

15. The method of claim 14, wherein the retention device is a retention cable.

16. The method of claim 14, wherein the retention device is a retention strap.

17. The method of claim 14, wherein the pipe includes interior threads and the pipe plug includes exterior threads and the pipe plug is rotated into the pipe.

18. The method of claim 17, wherein the retention device prevents the pipe plug from being rotated out of the pipe.

19. The method of claim 14, wherein the pipe plug includes a through-hole and the retention device includes a plug cover adapted to cover the pipe plug and the retention device further includes a through-the-hole lock inserted through the through-hole and secured to the plug cover.

20. The method of claim 14, wherein the pipe plug includes a pipe cap with interior threads and the pipe includes exterior threads and the pipe cap is rotated onto the pipe and the retention device prevents the pipe cap from being rotated off of the pipe.
